(19) United States
(12) Patent Application Publication
(10) Pub. No.: US 2025/0298466 A1
(43) Pub. Date: Sep. 25, 2025

(54) ADAPTIVE FOVEATION PROCESSING AND RENDERING IN VIDEO SEE-THROUGH (VST) EXTENDED REALITY (XR)

(71) Applicant: Samsung Electronics Co., Ltd., Suwon-si (KR)

(72) Inventors: Yingen Xiong, Mountain View, CA (US); Christopher A. Peri, Mountain View, CA (US)

(21) Appl. No.: 18/787,523

(22) Filed: Jul. 29, 2024

Related U.S. Application Data
(60) Provisional application No. 63/567,801, filed on Mar. 20, 2024.

(51) Int. Cl. G06F 3/01; G06T 19/20

(52) U.S. Cl. CPC G06F 3/013; G06F 3/012; G06T 19/20; G06T 2219/2016

(57) ABSTRACT

A method includes obtaining, using at least one processing device, images of a scene captured using one or more imaging sensors of a video see-through (VST) extended reality (XR) device. The method also includes identifying, using the at least one processing device, a region of the scene on which a user is focused. The method further includes generating, using the at least one processing device, a mask for each image based on the region of the scene on which the user is focused, where different masks are associated with different resolutions and/or different shapes. The method also includes mapping, using the at least one processing device, at least some image data of each image onto a mesh based on the mask associated with that image. In addition, the method includes rendering, using the at least one processing device, final views of the scene using the mapped image data.

### CROSS-REFERENCE TO RELATED APPLICATION AND PRIORITY CLAIM

This application claims priority under 35 U.S.C. § 119(e) to U.S. Provisional Patent Application No. 63/567,801 filed on Mar. 20, 2024. This provisional patent application is hereby incorporated by reference in its entirety.

### TECHNICAL FIELD

This disclosure relates generally to extended reality (XR) systems and processes. More specifically, this disclosure relates to adaptive foveation processing and rendering in video see-through (VST) XR.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to adaptive foveation processing and rendering in video see-through (VST) extended reality (XR).

In a first embodiment, a method includes obtaining, using at least one processing device of a VST XR device, images of a scene captured using one or more imaging sensors of the VST XR device. The method also includes identifying, using the at least one processing device, a region of the scene on which a user of the VST XR device is focused. The method further includes generating, using the at least one processing device, a mask for each image based on the region of the scene on which the user is focused, where different ones of the masks are associated with at least one of (i) different resolutions or (ii) different shapes. The method also includes mapping, using the at least one processing device, at least some image data of each image onto a mesh based on the mask associated with that image. In addition, the method includes rendering, using the at least one processing device, final views of the scene using the mapped image data of the images.

In a second embodiment, a VST XR device includes at least one display, one or more imaging sensors, and at least one processing device. The at least one processing device is configured to obtain images of a scene captured using the one or more imaging sensors and identify a region of the scene on which a user of the VST XR device is focused. The at least one processing device is also configured to generate a mask for each image based on the region of the scene on which the user is focused, where different ones of the masks are associated with at least one of (i) different resolutions or (ii) different shapes. The at least one processing device is further configured to map at least some image data of each image onto a mesh based on the mask associated with that image and render final views of the scene using the mapped image data of the images for presentation on the at least one display.

In a third embodiment, a non-transitory machine readable medium contains instructions that when executed cause at least one processor of a VST XR device to obtain images of a scene captured using one or more imaging sensors of the VST XR device and identify a region of the scene on which a user of the VST XR device is focused. The non-transitory machine readable medium also contains instructions that when executed cause the at least one processor to generate a mask for each image based on the region of the scene on which the user is focused, where different ones of the masks are associated with at least one of (i) different resolutions or (ii) different shapes. The non-transitory machine readable medium further contains instructions that when executed cause the at least one processor to map at least some image data of each image onto a mesh based on the mask associated with that image and render final views of the scene using the mapped image data of the images for presentation on at least one display of the VST XR device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process supporting adaptive foveation processing and rendering in video see-through (VST) extended reality (XR) in accordance with this disclosure;

FIG. 3 illustrates an example functional architecture supporting adaptive foveation processing and rendering in VST XR in accordance with this disclosure;

FIGS. 4A through 4C illustrate example operations of an architecture supporting adaptive foveation processing and rendering in VST XR in accordance with this disclosure;

FIG. 5 illustrates an example process for generating and using smart marks to support adaptive foveation processing and rendering in VST XR in accordance with this disclosure;

FIGS. 6A through 8B illustrate example smart masks used to support adaptive foveation processing and rendering in VST XR in accordance with this disclosure;

FIG. 9 illustrates an example process for identifying depth hierarchies and performing depth densification to support adaptive foveation processing and rendering in VST XR in accordance with this disclosure;

FIG. 10 illustrates an example process for performing object reconstruction and reprojection to support adaptive foveation processing and rendering in VST XR in accordance with this disclosure;

FIGS. 11A and 11B illustrate example results of adaptive foveation processing and rendering in VST XR in accordance with this disclosure; and

FIG. 12 illustrates an example method for adaptive foveation processing and rendering in VST XR in accordance with this disclosure.

### DETAILED DESCRIPTION

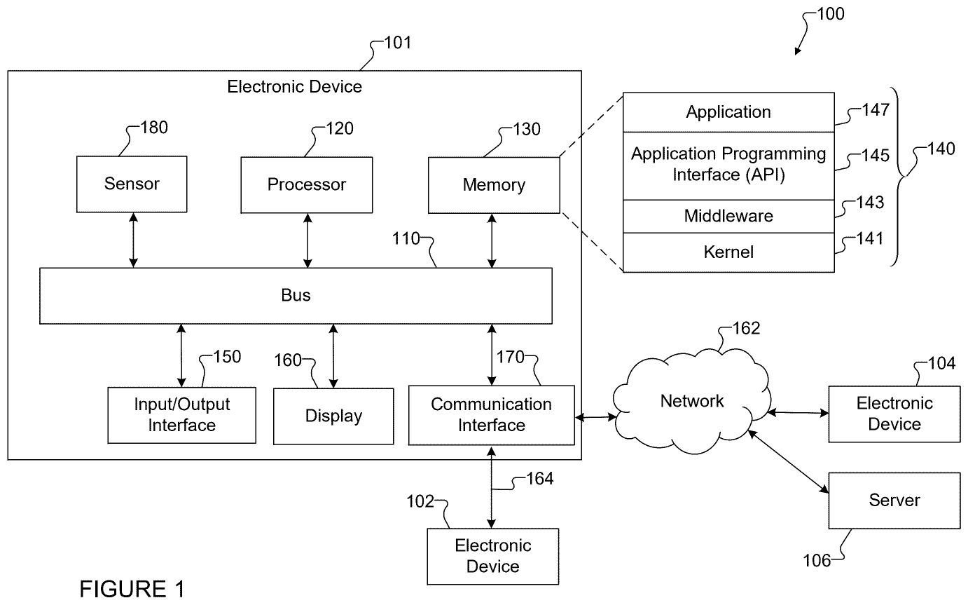

FIGS. 1 through 12, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

Many VST XR devices use high-resolution cameras, such as those that capture 3K or 4K images, along with high-resolution frame transformation and frame rendering, to generate images for display to users. However, the capture, processing, and rendering of high-resolution images can be computationally expensive, which can slow down generation and presentation of the images to the users. This latency can negatively affect a user's experience with a VST XR device, since latency in generating and presenting images to the user can be immediately noticed by the user. In some cases, larger latencies may cause the user to feel uncomfortable or even suffer from motion sickness or other effects.

This disclosure provides various techniques supporting adaptive foveation processing and rendering in VST XR. As described in more detail below, images of a scene can be captured using one or more imaging sensors of a VST XR device. A region of the scene on which a user of the VST XR device is focused can be identified, and a mask for each image can be generated based on the region of the scene on which the user is focused. Different masks can be associated with different resolutions and/or different shapes. For instance, in some embodiments, each mask could have a first shape or a second shape depending on whether the user is focusing on a closer object or a farther object in the scene. At least some image data of each image can be mapped onto a mesh based on the mask associated with that image, and final views of the scene can be rendered using the mapped image data of the images. In some cases, a depth hierarchy associated with certain depths within the scene can be generated for each image, and the depth hierarchy can define depths larger than a specified focal distance as background depths and depths smaller than the specified focal distance as foreground depths. The foreground depths in each depth hierarchy can be densified. Also, in some cases, image data of at least some of the images can be separated into foreground image data and background image data, and object reconstruction can be performed for each of those images. The object reconstruction can include reconstructing an object associated with the foreground image data in the region of the scene on which the user is focused, and at least some of the final views of the scene can be rendered using the reconstructed object. This can be performed for any number of images, such as sequences of images captured using left and right see-through cameras of the VST XR device.

In this way, these techniques allow for smart masks having different resolutions and different shapes to be generated according to (among other things) the contents of captured images and the user's focus. In some embodiments, the smart masks can be used to identify foveation regions based on where the user is currently focusing his or her attention, and the foveation regions can be reconstructed and reprojected adaptively according to the current status of a rendering pipeline. Moreover, the foveation regions associated with the user's focus can be rendered at higher resolution than other portions of images. As a result, the described techniques can reduce the processing load on a VST XR device and/or reduce latency in the VST XR device. The overall result is that final views of scenes can have a higher quality where desired based on the user's focus, which can increase user satisfaction and reduce or avoid problems like user discomfort or motion sickness.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to adaptive foveation processing and rendering in VST XR.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform adaptive foveation processing and rendering in VST XR. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit (IMU) that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to adaptive foveation processing and rendering in VST XR.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

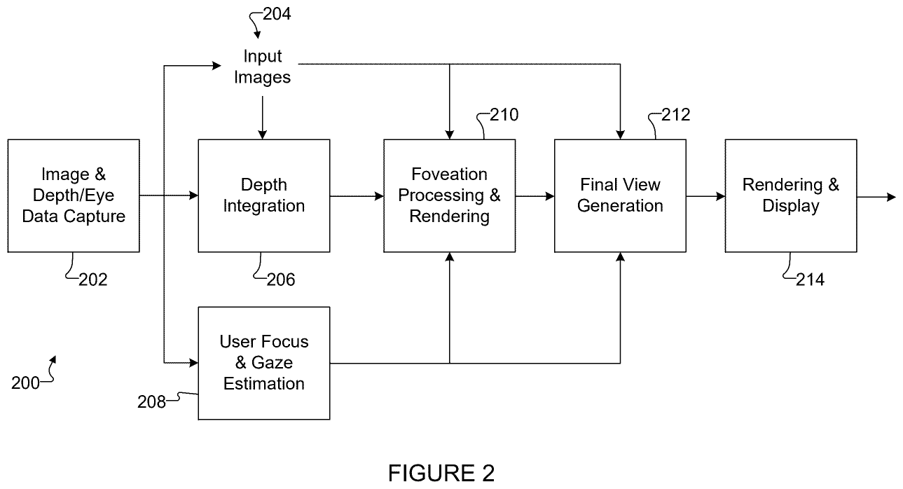

FIG. 2 illustrates an example process 200 supporting adaptive foveation processing and rendering in VST XR in accordance with this disclosure. For ease of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, the process 200 includes an image and depth/eye data capture operation 202, which generally operates to capture input images 204 and data associated with the input images 204. For example, the image and depth/eye data capture operation 202 may obtain input images 204 captured using one or more see-through cameras or other imaging sensors 180 of a VST XR device. In some cases, the image and depth/eye data capture operation 202 can obtain sequences of input images 204 captured using left and right see-through cameras of the VST XR device. The input images 204 can have any suitable size, shape, and dimensions and can be captured at any suitable frame rate. The image and depth/eye data capture operation 202 may also obtain depth maps or other depth data associated with the captured input images 204. The depth data can identify depths within the scene captured in the input images 204. In some embodiments, the depth maps or other depth data may be obtained using one or more depth sensors or other sensors 180 of the VST XR device. The image and depth/eye data capture operation 202 may further obtain data related to where the user is looking within the scene captured in the input images 204. In some embodiments, the data related to where the user is looking may include data from one or more IMUs, eye tracking cameras, or other sensors 180 of the electronic device 101.

The input images 204 and the depth data can be provided to a depth integration operation 206, which generally operates to produce additional depth data and combine the additional depth data with the depth maps or other depth data from one or more depth sensors or other sensors 180 of the VST XR device. For example, stereo pairs of input images 204 may be used to generate depth values associated with the scene captured in the input images 204. As a particular example, depth reconstruction may derive depth values in a scene based on stereo pairs of input images 204, where disparities in locations of common points in the stereo images are used to estimate depths. In some cases, these depths may be combined with depth maps or other depths determined using one or more depth sensors 180, which is often referred to as depth “densification.”

A user focus and gaze estimation operation 208 generally operates to process information in order to determine whether the user is focusing on any particular portion of a scene and (if so) where. The user focus and gaze estimation operation 208 can use any suitable technique to identify whether the user is focusing on a particular part of a scene and, if so, which part of the scene is the subject of that focus. In some cases, for instance, the user focus and gaze estimation operation 208 may use information from one or more eye tracking cameras, which can estimate the direction in which each of the user's eyes appears to be pointing. As a particular example, the user focus and gaze estimation operation 208 may use information from one or more eye tracking cameras that capture images of reflections of infrared or near-infrared light off the user's eyes in order to estimate where the user is gazing.

The input images 204, depth information, and user focus and gaze estimation information are provided to a foveation processing and rendering operation 210, which generally operates to determine how to perform foveation rendering of the input images 204. Foveation rendering refers to a process in which part of an image (typically the portion of a scene on which the user is focused) is rendered in higher resolution, while other parts of the image are rendered in lower resolution. This is based on the fact that each eye of an average person has a total field of view of about 120°, but each eye of the average person typically can focus over a field of view of about 200 to about 30°. This narrower field of view is typically referred to as a person's foveal vision, while the remainder of the total field of view (outside the person's foveal vision) is generally referred to as the person's peripheral vision.

The foveation processing and rendering operation 210 can operate based on the assumption that image contents where the user is focused can be rendered at higher resolution, while other image contents can be rendered at lower resolution. As described below, to support this functionality, the foveation processing and rendering operation 210 can generate smart masks with different resolutions and shapes according to the contents of the input images 204 in the regions of the scene where the user focuses. For each input image 204, the foveation processing and rendering operation 210 can identify a foveation region with the corresponding smart mask (based on the user's focus/gaze estimation), and image data and depth data can be mapped to the foveation region using the corresponding smart mask. The foveation region for each input image 204 can also be separated into a foreground and a background, and a depth hierarchy can be generated. The depth hierarchy for each of at least some of the input images 204 can be used to perform three-dimensional (3D) reconstruction for one or more foreground objects.

A final view generation operation 212 generally operates to produce images that represent final views of the scene captured in the input images 204. For example, the final view generation operation 212 may combine the 3D reconstruction(s) of the one or more foreground objects with simple planar reprojections or other reprojections of the background. The resulting images can have high quality in the foveation regions and can be generated with lower latency and lower computational load. Any reconstructed 3D objects may be stored, such as in the memory 130, and used when processing subsequent input images 204 of the same objects, which allows the VST XR device to retrieve the reconstructed objects from memory rather than generating them again. This can further reduce computational load on the VST XR device.

A rendering and display operation 214 generally operates to perform any additional refinements or modifications as needed or desired to the images produced by the final view generation operation 212. For example, a 3D-to-2D warping can be used to warp the final views of the scene into 2D images. The rendering and display operation 214 can also render the images into a form suitable for transmission to at least one display 160 and can initiate display of the rendered images, such as by providing the rendered images to one or more displays 160.

Although FIG. 2 illustrates one example of a process 200 supporting adaptive foveation processing and rendering in VST XR, various changes may be made to FIG. 2. For example, various components or operations in FIG. 2 may be combined, further subdivided, replicated, omitted, or rearranged and additional components or operations may be added according to particular needs.

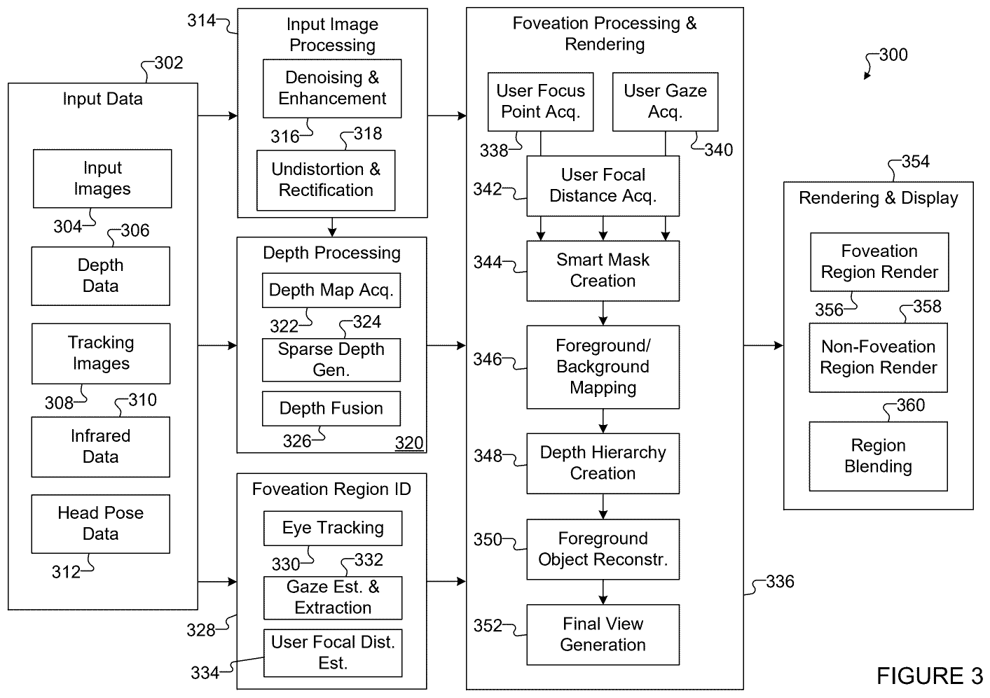

FIG. 3 illustrates an example functional architecture 300 supporting adaptive foveation processing and rendering in VST XR in accordance with this disclosure. For ease of explanation, the architecture 300 of FIG. 3 is described as being implemented using the electronic device 101 in the network configuration 100 of FIG. 1, which may be used to perform the process of FIG. 2. However, the architecture 300 may be implemented using any other suitable device(s) and in any other suitable system(s), and the architecture 300 may be used to perform any other suitable process(es).

As shown in FIG. 3, the architecture 300 is used to obtain and process various input data 302. In this example, the input data 302 includes input images 304, depth data 306, tracking images 308, infrared data 310, and head pose data 312. The input images 304 may represent images captured using one or more see-through cameras or other imaging sensors 180 of a VST XR device. The input images 304 can have any suitable size, shape, and dimensions and can be captured at any suitable frame rate. The depth data 306 may represent depth maps or other depth data associated with the captured input images 304, such as depth maps or other depth data obtained using one or more depth sensors or other sensors 180 of the VST XR device. The tracking images 308 may represent images of a user's eyes, such as images captured using one or more eye tracking cameras or other imaging sensors 180 of the VST XR device. The infrared data 310 may represent images or other data associated with infrared or near-infrared light reflected off the user's eyes, such as data from an infrared sensor or other sensors 180 of the VST XR device. The head pose data 312 may represent data defining or associated with the pose of the user's head within 3D space, such as data from one or more IMUs or other orientation sensors 180 of the VST XR device.

The input images 304 are provided to an input image processing function 314, which generally operates to pre-process the input images 304 and generate cleaner versions of the input images 304. In this example, the input image processing function 314 includes an image denoising and enhancement function 316, which can perform denoising and other image enhancement processing in order to remove noise, enhance edges or other image contents, or perform other functions on the contents of the input images 304. This effectively helps to improve the image quality of the input images 304.

The input image processing function 314 also includes an undistortion and rectification function 318, which generally operates to undistort and rectify the input images 304 (or the cleaner versions thereof). With respect to undistortion, a see-through camera or other imaging sensor 180 typically includes at least one lens, and the at least one lens can create radial, tangential, or other type(s) of distortion(s) in captured images. The undistortion and rectification function 318 may make adjustments to each input image 304 so that the resulting images substantially correct for the radial, tangential, or other type(s) of distortion(s). Among other things, the undistortion and rectification function 318 can remove distortions and obtain regular-shaped images. In some cases, the undistortion and rectification function 318 may include or have access to a camera matrix and a lens distortion model, which can be used to identify how each input image 304 should be adjusted so that the resulting image substantially corrects for the camera lens distortion(s). A camera matrix is often defined as a three-by-three matrix that includes two focal lengths in the x and y directions and the principal point of the camera defined using x and y coordinates. A lens distortion model is often defined as a mathematical model that indicates how images can be undistorted, which can be derived based on the specific lens or other optical component(s) being used. With respect to rectification, multiple input images 304 may be aligned or rectified to support other functions in an image processing pipeline. For instance, stereo pairs of images may be used to generate depth values associated with a scene as described above. Multiple images from the same imaging sensor 180 or different imaging sensors 180 may be rectified to support this or other image processing functions.

The depth data 306 and the rectified versions of the input images 304 are provided to a depth processing function 320, which generally operates to densify the available depth data. In this example, the depth processing function 320 includes a depth map acquisition function 322, which can obtain depth maps or other depth data 306 from the one or more depth sensors or other sensors 180 of the VST XR device. The depth processing function 320 also includes a sparse depth generation function 324, which can use stereo image pairs provided by the input image processing function 314 to estimate sparse depths within captured scenes. For example, the depth processing function 320 can use disparities of common points in the stereo image pairs to estimate the sparse depths. The depth processing function 320 further includes a depth fusion function 326, which can combine the depth maps, sparse depths, or other depth information in order to generate higher-resolution depth maps or other higher-resolution depth data.

The tracking images 308, infrared data 310, or other information is provided to a foveation region identification (ID) function 328, which generally operates to identify foveation regions. The foveation regions define or are associated with regions of the input images 304 representing portions of the captured scenes on which the user of the VST XR device is focused. In this example, the foveation region identification function 328 includes an eye tracking function 330, which can track the movements of the user's eyes over time. This information may be used to determine whether the user appears focused on a particular area of a scene or is changing his or her area of focus. The foveation region identification function 328 also includes a gaze estimation and extraction function 332, which can estimate the direction(s) that the user appears to be gazing over time. In some cases, this can be done using images from the one or more eye tracking cameras and/or images of reflected infrared or near-infrared light from the user's eyes. The foveation region identification function 328 further includes a user focal distance estimation function 334, which can estimate the focal distance at which the user appears to be focused. In some cases, this may be based on determining the distance to a common point on which both of the user's eyes appear to be directed. Thus, for instance, the focal distance is closer when the user's eyes are directed more inward and farther when the user's eyes are directed more outward.

A foveation processing and rendering function 336 obtains and processes the various outputs provided by the functions 314, 320, 328 and generally operates to determine how to perform foveation rendering of the input images 304. In this example, the foveation processing and rendering function 336 includes a user focus point acquisition function 338, a user gaze acquisition function 340, and a user focal distance acquisition function 342. These functions 338-342 can be used to obtain the point where the user's eyes appear to be focused, a direction in which the user appears to be gazing, and the focal distance of the user's eyes from the foveation region identification function 328.

A smart mask creation function 344 uses this information to generate smart masks associated with the input images 304. Assuming the user is focused on a particular region of a scene, each smart mask identifies a portion of at least one input image 304, where that portion corresponds to the particular region of the scene on which the user is focused. In other words, each smart mask can identify a foveation region in the at least one input image 304. The foveation region for each input image 304 can have a suitable size, shape, and resolution (or any combination thereof) based on the contents of the scene. If the user is not focused on a particular region of the scene, the smart masks may not identify a foveation region. This allows the smart mask creation function 344 to adaptively create and fit smart masks to the contents of the input images 304 representing the regions of the scenes on which the user is focused.

A foreground/background mapping function 346 can be used to separate each of the input images 304 into a foreground scene and a background scene or to otherwise separate the input image 304 into foreground image content and background image content. For example, the foreground/background mapping function 346 may use the user's estimated focal distance to separate each input image 304, where image content and depths closer than the user's focal distance are treated as an image foreground and image content and depths farther than the user's focal distance are treated as an image background. The foreground/background mapping function 346 also maps one or more portions of the image foreground and/or one or more portions of the image background for each input image 304 onto the foveation region for that input image 304, which can be done using the smart mask for that input image 304.

A depth hierarchy creation function 348 can generate a depth hierarchy for at least the foveation region of each input image 304. For example, each depth hierarchy may identify different depths of different image contents within the foveation region of the associated input image 304. The depth hierarchy creation function 348 can also densify the depths within the foveation region of each input image 304, such as by performing depth noise reduction and depth propagation. This allows the depth hierarchy creation function 348 to generate dense depth maps or other dense depth data within the depth hierarchy for the foveation region of each input image 304. The depth hierarchy creation function 348 can also filter the depth data, such as to smooth the depth data.

A foreground object reconstruction function 350 can be used to perform 3D object reconstruction for any objects within the foreground of the foveation region of each input image 304. For example, the foreground object reconstruction function 350 can use the densified depths defined by the associated depth hierarchy to generate a 3D reconstruction of each object within the foreground of the foveation region of an input image 304. Each 3D reconstructed object can be produced using the corresponding foreground depths and any suitable texture(s) of the associated object. As described below, information defining reconstructed objects can be stored (such as in the memory 130) for use with subsequent input images 304.

A final view generation function 352 can reproject any 3D object reconstruction for any object within the foveation region of each input image 304 and can reproject the background of each input image 304. For example, the final view generation function 352 can apply at least one transformation to one or more 3D object reconstructions based on an estimated head pose of the user. As particular examples, the final view generation function 352 can apply one or more translations and/or one or more rotations to the one or more 3D object reconstructions based on the estimated head pose of the user. The final view generation function 352 can also reproject the image background for each input image 304 based on the estimated head pose of the user. In some cases, the reprojection of the object(s) in the foreground of each foveation region can be more accurate (such as when depth-based reprojection is used), and the reprojection of the background can be less accurate (such as when planar reprojection is used). For instance, spatial reprojection (also known as late-stage reprojection or “LSR”) may be used to reproject background image data onto a single plane. This can help to reduce computation load and/or reduce latency in the architecture 300.

The final views of the scene are provided to a rendering and display function 354, which generally operates to render the final views and initiate display of the resulting rendered images. In this example, the rendering and display function 354 includes a foveation region rendering function 356 and a non-foveation region rendering function 358. The foveation region rendering function 356 can render image data in the foveation region associated with each input image 304, and the non-foveation region rendering function 358 can render the image data in other regions associated with each input image 304. A region blending function 360 can be used to blend the rendered image data in the different regions so that the borders between the different regions is less obvious. Any suitable blending technique may be used by the region blending function 360 to blend image data in different regions of an image, such as weighted blending.

Although FIG. 3 illustrates one example of a functional architecture 300 supporting adaptive foveation processing and rendering in VST XR, various changes may be made to FIG. 3. For example, various components or functions in FIG. 3 may be combined, further subdivided, replicated, omitted, or rearranged and additional components or functions may be added according to particular needs.

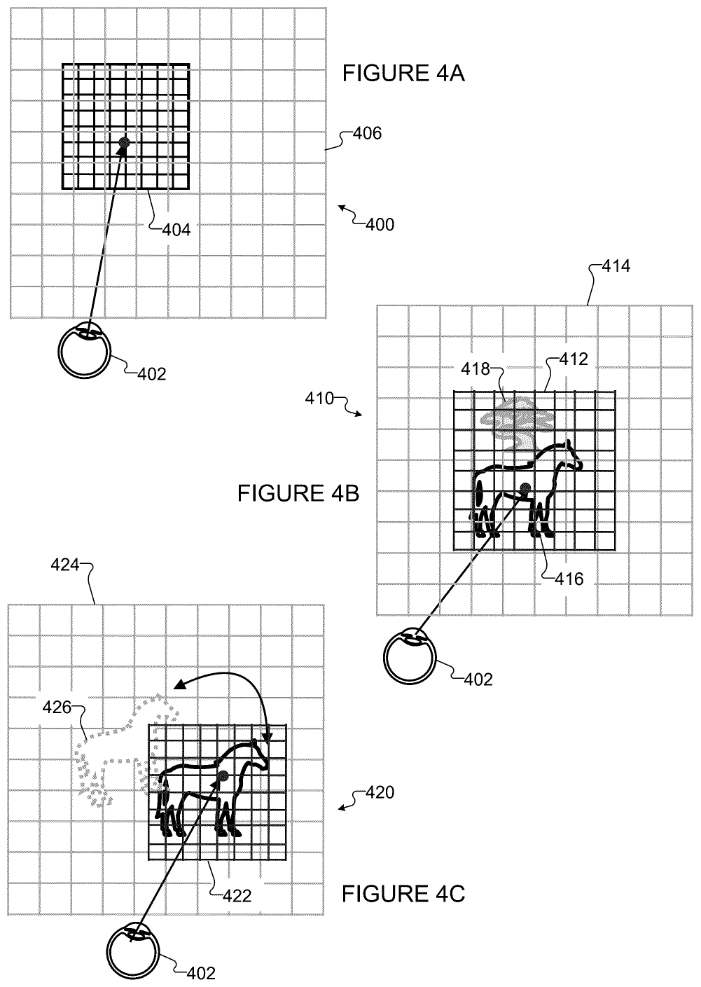

FIGS. 4A through 4C illustrate example operations of the architecture 300 supporting adaptive foveation processing and rendering in VST XR in accordance with this disclosure. As shown in FIG. 4A, a smart mask 400 is defined and used to process a captured input image 304 so that an associated rendered image can be presented for viewing by a user's eye 402. The smart mask 400 includes a first region 404, which represents a foveation region associated with a portion of a scene on which the user's eye 402 is focused. The smart mask 400 also includes a second region 406, which represents a peripheral or other non-foveation region. Each region 404 and 406 has a corresponding mesh pattern formed by lines that intersect one another. The mesh pattern of the first region 404 has lines that are closer together compared to the mesh pattern of the second region 406. This indicates that the first region 404 can have a higher resolution compared to the second region 406. Moreover, the actual size, shape, and/or position of the first region 404 within the scene can vary based on the contents of the scene and where the user is focused. Thus, for instance, the size, shape, and/or position of the first region 404 can vary based on the positions of various objects within the scene and which object the user is currently directing his or her focus.

As shown in FIG. 4B, a smart mask 410 is associated with a first (foveation) region 412 and a second (non-foveation) region 414, and multiple objects 416 and 418 (an animal and a tree in this example) are captured within the first region 412. The generation of a depth hierarchy for the first region 412 and the densification of the depth values for the depth hierarchy (along with depth noise reduction and depth propagation) can help to ensure that more-accurate depths are available for reprojection of the objects within the first region 412. For example, when the objects 416 and 418 are located at different depths within the scene, the depth hierarchy and the improved depth values can allow for more-accurate reprojection of both objects 416 and 418. Image contents within the second region 414 may undergo planar reprojection or other simpler reprojection to help reduce computational load.

As shown in FIG. 4C, a smart mask 420 is associated with a first (foveation) region 422 and a second (non-foveation) region 424. A 3D reconstruction of an object 426 within the first region 422 can be generated by the architecture 300 and used during reprojection of the image data within the first region 422. Moreover, the 3D reconstruction of the object 426 can be stored and used with subsequent input images 304. Thus, for instance, if the user's head pose changes, the 3D reconstruction of the object 426 can be retrieved from memory rather than recreated, and the retrieved 3D reconstruction of the object 426 can be reprojected to compensate for the user's head pose change.

Although FIGS. 4A through 4C illustrate examples of operations of the architecture 300 supporting adaptive foveation processing and rendering in VST XR, various changes may be made to FIGS. 4A through 4C. For example, the contents of a scene being imaged can vary widely based on the circumstances, and the specific smart maps generated for images of the scene can similarly vary widely based on the circumstances.

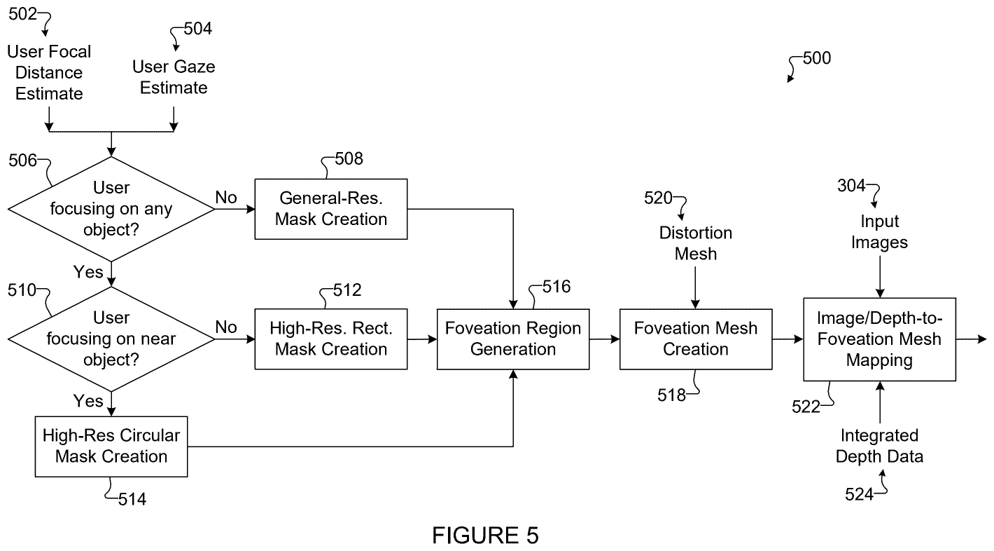

FIG. 5 illustrates an example process 500 for generating and using smart marks to support adaptive foveation processing and rendering in VST XR in accordance with this disclosure. The process 500 may, for example, be used to at least partially implement the smart mask creation function 344 and the foreground/background mapping function 346 described above. As shown in FIG. 5, a user focal distance estimate 502 and a user gaze estimate 504 can be obtained, such as from the foveation region identification function 328. A determination function 506 determines whether the user is focusing on any objects within a scene. For example, the determination function 506 can use the estimated direction in which the user is gazing and the estimated focal distance of the user to determine if there is at least one object within the scene in that direction at that distance. If not, a general-resolution mask creation function 508 can be used to generate a mask that does not identify any specific foveation regions. In some cases, this mask may have a lower resolution throughout since the user is not focusing on any specific region.

Otherwise, the user is focusing on an object in the scene, and a determination function 510 determines whether the user is focusing on a near object. For example, the determination function 510 may determine if the estimated focal distance is greater than or less than a specified threshold distance. If the user is not focusing on a near object, a high-resolution rectangular mask creation function 512 can be used to generate a rectangular mask. The rectangular mask can define a square or other rectangular region that includes the object on which the user is focused. If the user is focusing on a near object, a high-resolution circular mask creation function 514 can be used to generate a circular mask. The circular mask can define a circular or elliptical region that includes the object on which the user is focused. In either case, the smart mask defined here can have a higher resolution in the region including the object on which the user is focused and a lower resolution elsewhere.

A foveation region generation function 516 can be used to define a foveation region, such as by identifying a square/rectangular or circular/elliptical region of each input image 304 falling within the higher-resolution portion of the corresponding rectangular or circular mask that includes the object on which the user is focused. The size of the foveation region here is based at least in part on the size of the object on which the user is focused. A foveation mesh creation function 518 can be used to generate a foveation mesh for each identified foveation region. For instance, the foveation mesh creation function 518 can obtain at least one passthrough distortion mesh 520, which can represent a static transformation used to provide viewpoint matching, parallax correction, and principal point matching. Viewpoint matching refers to transforming images captured using see-through cameras or other imaging sensors 180 at certain locations so that the images appear to have been captured at locations of the user's eyes. Parallax correction refers to transforming images so that points within displayed images are located at appropriate positions to achieve desired parallax. Principal point matching refers to transforming images in order to align principal points of the see-through cameras or other imaging sensors 180 and principal points of one or more displays 160 on which rendered images are displayed to the user. Each passthrough distortion mesh 520 can collectively implement these various transformations, and the foveation mesh creation function 518 can extract a portion of the passthrough distortion mesh 520 associated with each identified foveation region.

An image and depth data-to-foveation mesh mapping function 522 maps image data from the input images 304 and integrated depth data 524 from the depth processing function 320 onto the foveation meshes associated with the input images 304. For example, the image and depth data-to-foveation mesh mapping function 522 can determine which pixel data values of the input images 304 and which depth values of the integrated depth data 524 fall within the foveation meshes. The mapped data can be used by subsequent functions in the foveation processing and rendering function 336.

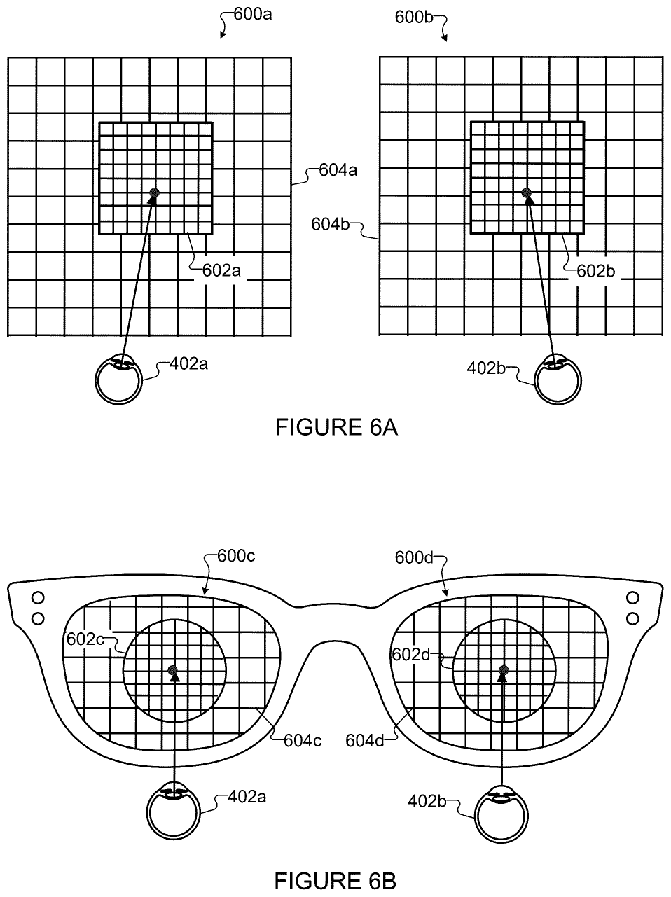

FIGS. 6A through 8B illustrate example smart masks used to support adaptive foveation processing and rendering in VST XR in accordance with this disclosure. As shown here, FIG. 6A illustrates example rectangular smart masks 600a-600b, which include or are associated with first (foveation) regions 602a-602b and second (non-foveation) regions 604a-604b. The first regions 602a-602b are associated with areas of a scene on which the user's eyes 402a-402b are focused, and the second regions 604a-604b are associated with areas of the scene on which the user's eyes 402a-402b are not focused. FIG. 6B illustrates example circular smart masks 600c-600d, which include or are associated with first (foveation) regions 602c-602d and second (non-foveation) regions 604c-604d. Again, the first regions 602c-602d are associated with areas of a scene on which the user's eyes 402a-402b are focused, and the second regions 604c-604d are associated with areas of the scene on which the user's eyes 402a-402b are not focused. The first regions 602a-602d can have higher resolution than their respective second regions 604a-604d.

As can be seen here, smart masks can define regions with different resolutions and different shapes for creating foveation regions in different applications or use cases. Thus, for example, based on the user's focal distances and focused objects, different smart masks can be created to define different foveation regions. While higher-resolution rectangular and circular regions of certain sizes are shown here, foveation regions with other shapes and sizes may be created.

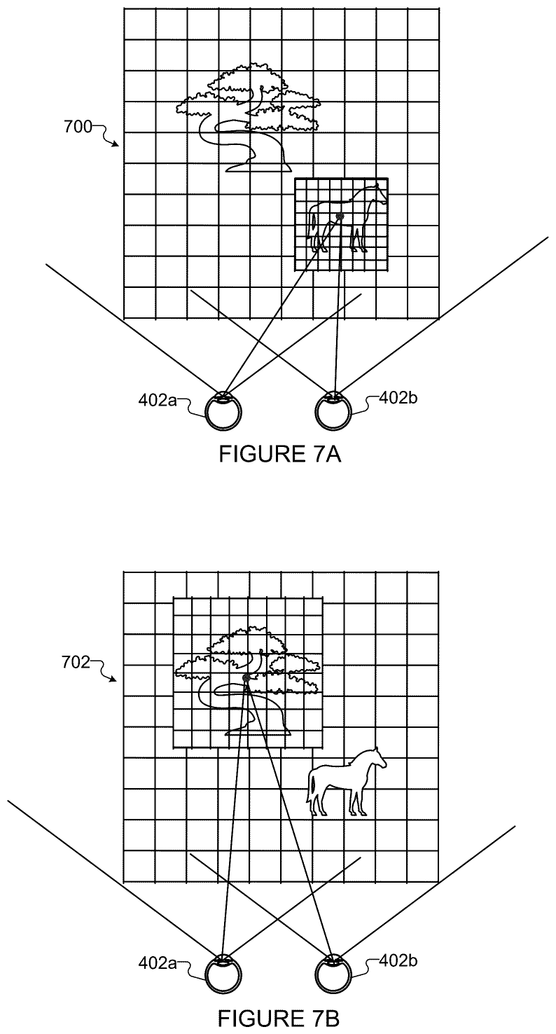

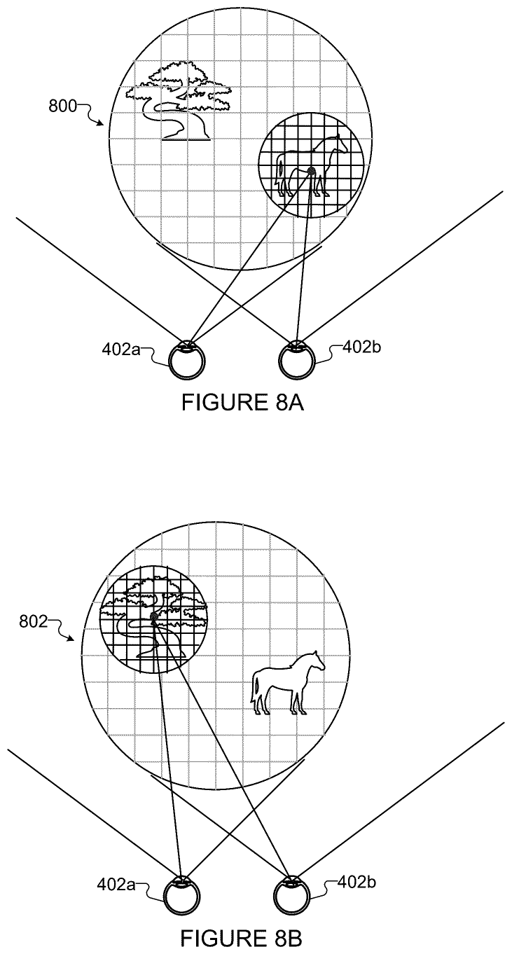

FIGS. 7A and 7B illustrate example smart masks 700 and 702 that may be generated using the approach of FIG. 6A, where different ones of the smart masks 700 and 702 are associated with user focus on different objects in a scene. Similarly, FIGS. 8A and 8B illustrate example smart masks 800 and 802 that may be generated using the approach of FIG. 6B, where different ones of the smart masks 800 and 802 are associated with user focus on different objects in a scene. As can be seen here, the smart masks that are generated can vary based on the image contents and where the user is focused within a scene, and the smart masks can be dynamically generated and adapted based on changing circumstances.

Although FIG. 5 illustrates one example of a process 500 for generating and using smart marks to support adaptive foveation processing and rendering in VST XR, various changes may be made to FIG. 5. For example, various components or functions in FIG. 5 may be combined, further subdivided, replicated, omitted, or rearranged and additional components or operations may be added according to particular needs. Although FIGS. 6A through 8B illustrate examples of smart masks used to support adaptive foveation processing and rendering in VST XR, various changes may be made to FIGS. 6A through 8B. For instance, the specific shapes of the smart masks and their individual regions and the specific arrangements of those regions in the smart masks can vary depending on the implementation and the specific circumstances.

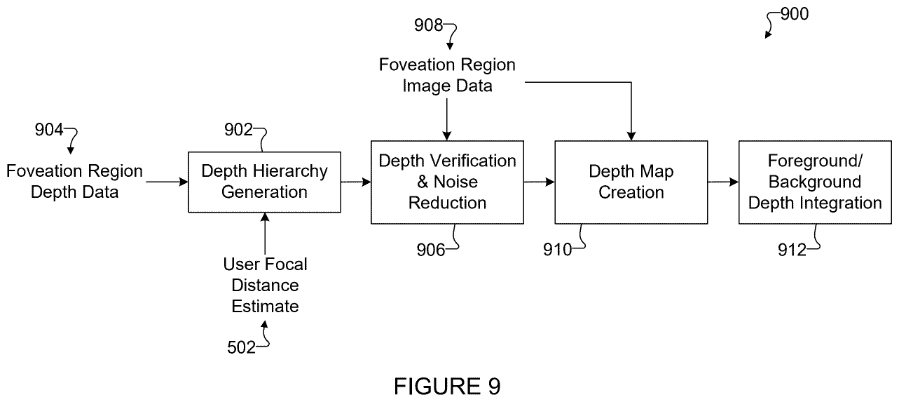

FIG. 9 illustrates an example process 900 for identifying depth hierarchies and performing depth densification to support adaptive foveation processing and rendering in VST XR in accordance with this disclosure. The process 900 may, for example, be used to at least partially implement the depth hierarchy creation function 348 described above. As shown in FIG. 9, a depth hierarchy generation function 902 can receive foveation region depth data 904 for each input image 304, where the foveation region depth data 904 represents the depth data for that input image 304 mapped to a foveation region (if any) for that input image 304 by the image and depth data-to-foveation mesh mapping function 522. The depth hierarchy generation function 902 can also receive the user focal distance estimate 502 for each input image 304. The depth hierarchy generation function 902 can use this information to generate a depth hierarchy for the foveation region of each input image 304 (if any), where the depth hierarchy separates foreground and background depths. For instance, the depth hierarchy generation function 902 may define depths larger than the associated user focal distance estimate 502 in a foveation region as background depths and define depths smaller than the associated user focal distance estimate 502 in the foveation region as foreground depths. In some embodiments, each depth hierarchy can use a single depth (such as the corresponding user focal distance estimate 502) as a replacement for the background depths in the depth hierarchy.

A depth verification and noise reduction function 906 can be used to verify the depths contained in the depth hierarchies and to filter or otherwise remove noise from the depth hierarchies. For example, the depth verification and noise reduction function 906 can receive foveation region image data 908 for each input image 304, where the foveation region image data 908 represents the image data for that input image 304 mapped to the foveation region (if any) for that input image 304 by the image and depth data-to-foveation mesh mapping function 522. As a particular example, the depth verification and noise reduction function 906 can use image data from stereo image pairs to estimate depths and verify whether the depths contained in the depth hierarchies are the same as or substantially similar to the computed depths (such as within a desired threshold amount or percentage). Any depths contained in the depth hierarchies that appear incorrect may be replaced or otherwise processed to reduce or eliminate the discrepancies. The depth verification and noise reduction function 906 can also apply filtering to the depth data in order to smooth the depth data.

A depth map creation function 910 can be used to process the depth data from the depth verification and noise reduction function 906 and the foveation region image data 908 in order to generate dense depth maps or other dense depth data for the identified foveation regions. For example, the depth map creation function 910 may densify the foreground depth data in the depth hierarchy for each input image 304, such as by using depth propagation. Since the depth verification and noise reduction function 906 already clarified the depths, it is possible for the depth map creation function 910 to propagate sparse depths to and through the foveation region associated with each input image 304. As a particular example, sparse depths for each input image 304 (such as those provided by the depth verification and noise reduction function 906) may remain unchanged and be propagated to unknown depth points associated with the input image 304.

A foreground/background depth integration function 912 can be used to combine higher-resolution depth values for the foreground (in the foveation region) of each input image 304 with lower-resolution depth values for the background (in the foveation region and in non-foveation regions) of that input image 304. In some cases, the foreground/background depth integration function 912 could simply combine the depth map produced by the depth map creation function 910 for each input image 304 and the background depths for the background of that input image 304 to generate the integrated depths. The integrated depths may be provided to the foreground object reconstruction function 350 or other function(s).

Although FIG. 9 illustrates one example of a process 900 for identifying depth hierarchies and performing depth densification to support adaptive foveation processing and rendering in VST XR, various changes may be made to FIG. 9. For example, various components or functions in FIG. 9 may be combined, further subdivided, replicated, omitted, or rearranged and additional components or operations may be added according to particular needs. Also, while FIG. 9 illustrates one example technique for generating densified depth data, any other suitable technique may be used. For instance, a dense neural network (DNN) or other machine learning model may be trained to process sparse depths in at least foveation regions to create dense depth maps, and the dense depth maps may be verified and used as described above.

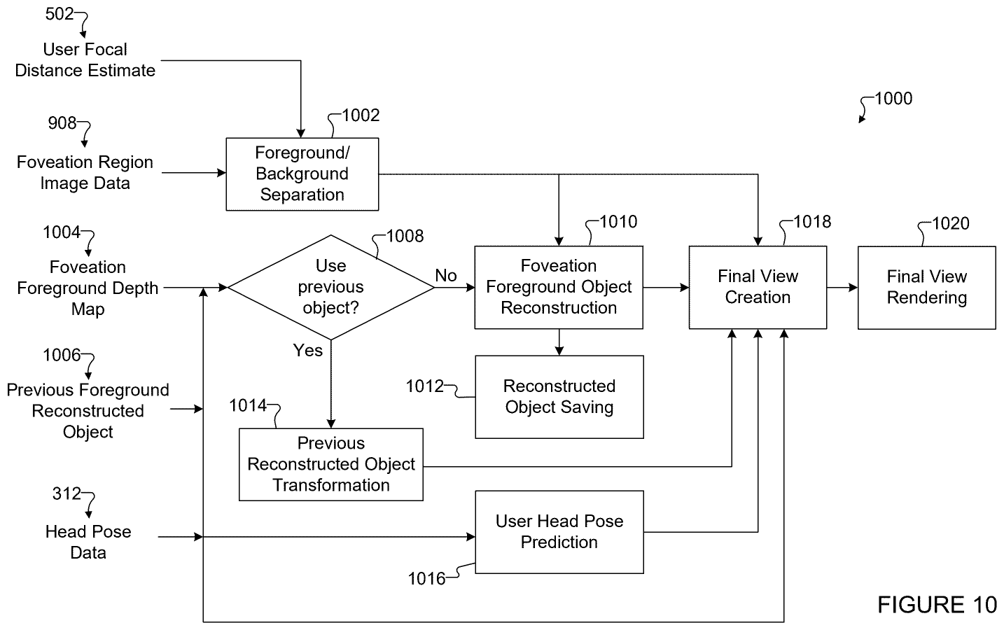

FIG. 10 illustrates an example process 1000 for performing object reconstruction and reprojection to support adaptive foveation processing and rendering in VST XR in accordance with this disclosure. The process 1000 may, for example, be used to at least partially implement the foreground object reconstruction function 350, the final view generation function 352, and the rendering and display function 354 described above. As shown in FIG. 10, the process 1000 includes receiving the user focal distance estimate 502 and the foveation region image data 908 for each input image 304. This information is provided to a foreground/background separation function 1002, which separates the foveation region image data 908 for each input image 304 into foreground image data and background image data. In some cases, this can be based on the user focal distance estimate 502 for each input image 304, such as when image data associated with depths larger than the user focal distance estimate 502 is treated as background data and image data associated with depths smaller than the user focal distance estimate 502 is treated as foreground data. The foreground data can be subsequently used to perform 3D object reconstruction.

The process 1000 also includes receiving a foveation foreground depth map 1004 for each input image 304, which could represent a depth map generated by the depth map creation function 910. The process 1000 may optionally include receiving or having access to one or more previous foreground reconstructed objects 1006, which can represent one or more 3D object reconstructions for one or more 3D objects previously captured in input images 304. In addition, the process 1000 can receive the head pose data 312, which can relate to one or more head poses or head pose changes by the user over time. A determination function 1008 can use this information to determine whether any previous foreground reconstructed object 1006 may be used to reconstruct an object for a current input image 304. For example, the determination function 1008 may determine whether the same 3D object was previously reconstructed at or around the same depth and at or around the same user head pose.

If the determination function 1008 determines that a previous foreground reconstructed object 1006 may not be used to reconstruct the object for the current input image 304, a foveation foreground object reconstruction function 1010 can be performed to process the foreground image data from the foreground/background separation function 1002 and reconstruct a 3D foreground object captured in an input image 304. For example, the foveation foreground object reconstruction function 1010 can take the image data and depth data associated with an object captured in the foreground of an input image 304 and use the image data and depth data to identify a 3D structure of the object. The 3D reconstruction of the object is saved using an object reconstruction saving function 1012, which can save the 3D reconstruction in the memory 130 or other location. The saved 3D reconstruction may subsequently be used as one of the previous foreground reconstructed objects 1006 for another input image 304. If the determination function 1008 determines that a previous foreground reconstructed object 1006 may be used to reconstruct the object for the current input image 304, a previous reconstructed object transformation function 1014 can be performed, which can transform and update the previous foreground reconstructed object 1006. For instance, the previous reconstructed object transformation function 1014 may apply a translation, a rotation, or both to the previous foreground reconstructed object 1006 based on the current location and orientation of the VST XR device.

A user head pose prediction function 1016 generally operates to predict how the user's head pose might change in the future. For example, there is typically a delay between capture of images and display of corresponding rendered images in a VST XR device, and it is possible for the user to move his or her head during that intervening time period. The user head pose prediction function 1016 can use the head pose data 312 (such as from an IMU, tracking camera, or other source) to predict how the user's head pose is expected to change between capture of images and display of corresponding rendered images. The user head pose prediction function 1016 may use any suitable technique to predict the user's head pose, such as by using a head pose model that predicts the user's future head pose or head pose changes based on the user's current and prior head poses or head pose changes.

A final view creation function 1018 can generate final image corresponding to the input images 304 by reprojecting reconstructed foreground objects and background scenes based on the predicted head pose of the user. As part of this, the final view creation function 1018 can modify each 3D reconstructed object from the foveation foreground object reconstruction function 1010 or the previous foreground reconstructed object 1006 from the previous reconstructed object transformation function 1014 to account for the user's predicted head pose. For example, the final view creation function 1018 may apply a translation, a rotation, or both to the 3D reconstructed object in order to account for the user's predicted head pose. As a result, the transformed 3D reconstructed object can appear as if it was captured by a camera at the user's predicted head pose. Here, the reconstructed foreground objects can be reprojected with accurate reprojections, while the background scenes could be reprojected with a simpler reprojection to reduce computational load. A final view rendering function 1020 can render the final images for presentation on one or more displays 160 of the VST XR device.

Although FIG. 10 illustrates one example of a process 1000 for performing object reconstruction and reprojection to support adaptive foveation processing and rendering in VST XR, various changes may be made to FIG. 10. For example, various components or functions in FIG. 10 may be combined, further subdivided, replicated, omitted, or rearranged and additional components or operations may be added according to particular needs. Also, the process 1000 is described as reprojecting foreground objects and background scenes separately. However, it is possible to reproject foreground objects and background scenes together, such as by generating dense depth maps for entire foveation regions and performing depth-based reprojection for the entire foveation regions. Note that during depth-based reprojection, it may be assumed that the user's focal point does not change, which is reasonable due to the very short time associated with each input image 304.

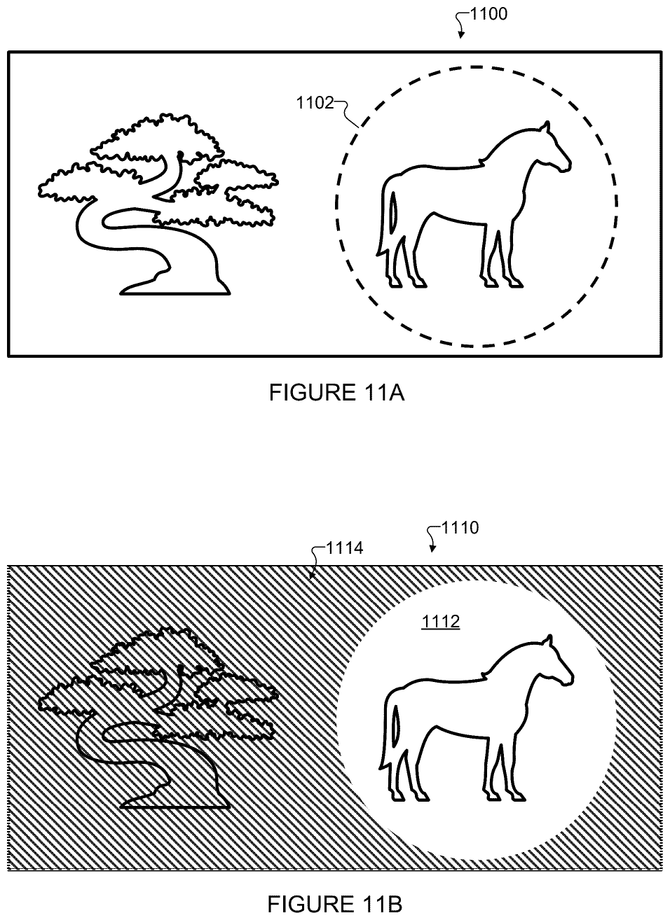

FIGS. 11A and 11B illustrate example results of adaptive foveation processing and rendering in VST XR in accordance with this disclosure. As shown in FIG. 11A, an input image 1100 represents an image captured using a see-through camera or other imaging sensor 180 of a VST XR device. A region 1102 represents or is associated with a foveation region in the scene, meaning the user is focusing on the right object and not the left object captured in the input image 1100. As shown in FIG. 11B, a final output image 1110 rendered for presentation to a user includes a higher-resolution region 1112 and a lower-resolution region 1114. Because of this, the region on which the user is focused appears clearer, while regions on which the user is not focused can have lower quality. As noted above, blending could be used at the border between the two regions 1112-1114 so that there is not a sharp change in resolution along the border.

Although FIGS. 11A and 11B illustrate examples of results of adaptive foveation processing and rendering in VST XR, various changes may be made to FIGS. 11A and 11B. For example, the specific scene being imaged and the foveation regions within the images can vary widely based on the circumstances.

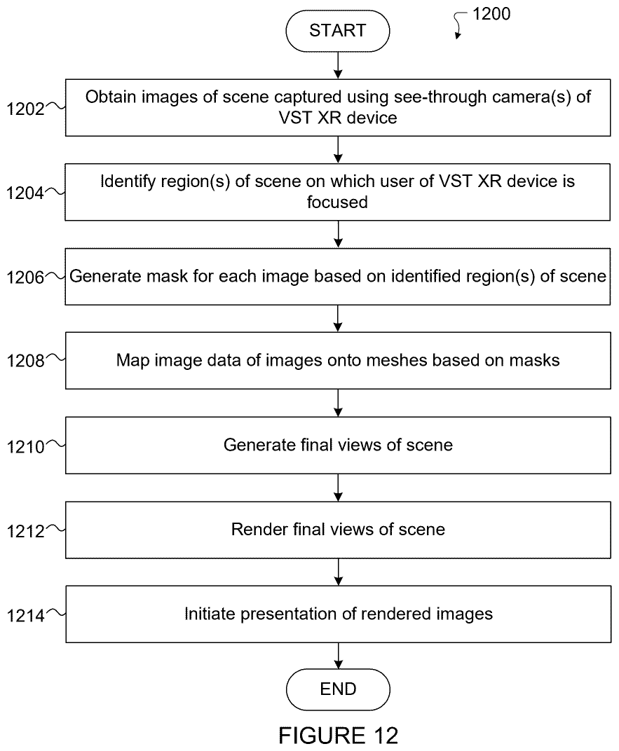

FIG. 12 illustrates an example method 1200 for adaptive foveation processing and rendering in VST XR in accordance with this disclosure. For ease of explanation, the method 1200 of FIG. 12 is described as being performed using the electronic device 101 in the network configuration 100 of FIG. 1, where the electronic device 101 can implement the architecture 300 of FIG. 3 and perform the process of FIG. 2. However, the method 1200 may be performed using any other suitable device(s) and architecture(s) and in any other suitable system(s), and the method 1200 may be used to form any other suitable process.

As shown in FIG. 12, images of a scene captured using one or more imaging sensors of a VST XR device are obtained at step 1202. This could include, for example, the processor 120 of the electronic device 101 obtaining input images 204, 304 captured using one or more see-through cameras or other imaging sensors 180 of the VST XR device. At least one region of the scene on which a user of the VST XR device is focused is identified at step 1204. This could include, for example, the processor 120 of the electronic device 101 analyzing eye tracking data or other data in order to estimate the user's focus point, gaze direction, and focal distance.

A mask is generated for each image based on the region(s) of the scene on which the user of the VST XR device is focused at step 1206. This could include, for example, the processor 120 of the electronic device 101 generating a smart mask for each image 204, 304. Each smart mask could have one form (such as rectangular) or another form (such as circular) depending on whether the user is focusing on a closer object or a farther object, and the smart masks can be used to define foveation regions associated with the images. Image data of each of the images is mapped onto a mesh that is based on the corresponding mask at step 1208. This could include, for example, the processor 120 of the electronic device 101 mapping the image data from the input images 204, 304 onto meshes defined using the smart masks for those input images 204, 304. As a result, this maps image data in at least the foveation regions onto the corresponding meshes. This may also include mapping depths associated with the input images 204, 304 onto the meshes.

Final views of the scene are generated at step 1210. This could include, for example, the processor 120 of the electronic device 101 generating depth hierarchies separating depths for each image 204, 304 into foreground and background depths based on the user's focal distance and verifying and propagating the foreground depths in order to densify the foreground depths at least within the foveation regions. This could also include the processor 120 of the electronic device 101 separating the image data of at least some of the images 204, 304 into foreground image data and background image data at least within the foveation regions. This could further include the processor 120 of the electronic device 101 performing object reconstruction for one or more objects within the foreground of the foveation region of each image 204, 304 or using one or more previously reconstructed objects. In addition, this could include the processor 120 of the electronic device 101 performing reprojection of the reconstructed 3D objects and the background image content, such as to provide head pose change compensation.

The final views are rendered at step 1212, and presentation of the resulting rendered images is initiated at step 1214. This could include, for example, the processor 120 of the electronic device 101 rendering the final views into a form suitable for display and communicating the resulting image data to the display(s) 160 of the electronic device 101 for presentation.

Although FIG. 12 illustrates one example of a method 1200 for adaptive foveation processing and rendering in VST XR, various changes may be made to FIG. 12. For example, while shown as a series of steps, various steps in FIG. 12 may overlap, occur in parallel, occur in a different order, or occur any number of times (including zero times). Also, various steps in FIG. 12 may be repeated in order to process any suitable number of images from any suitable number of imaging sensors, such as to process sequences of images from left and right see-through cameras or other collections of imaging sensors.

It should be noted that the functions described above can be implemented in an electronic device 101, 102, 104, server 106, or other device(s) in any suitable manner. For example, in some embodiments, at least some of the functions can be implemented or supported using one or more software applications or other software instructions that are executed by the processor 120 of the electronic device 101, 102, 104, server 106, or other device(s). In other embodiments, at least some of the functions can be implemented or supported using dedicated hardware components. In general, the functions described above can be performed using any suitable hardware or any suitable combination of hardware and software/firmware instructions. Also, the functions described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of a video see-through (VST) extended reality (XR) device, images of a scene captured using one or more imaging sensors of the VST XR device;
identifying, using the at least one processing device, a region of the scene on which a user of the VST XR device is focused;
generating, using the at least one processing device, a mask for each image based on the region of the scene on which the user is focused, wherein different ones of the masks are associated with at least one of (i) different resolutions or (ii) different shapes;
mapping, using the at least one processing device, at least some image data of each image onto a mesh based on the mask associated with that image; and
rendering, using the at least one processing device, final views of the scene using the mapped image data of the images.

2. The method of claim 1, wherein:
the mask associated with each image identifies the region of the scene on which the user is focused; and
a portion of the mask associated with the region of the scene on which the user is focused has a higher resolution than one or more other portions of the mask.

3. The method of claim 1, wherein generating the mask for each image comprises generating, for each image, a mask defining a region with a first shape or a second shape depending on whether the user is focusing on a closer or farther object in the scene.

4. The method of claim 1, further comprising:
generating a depth hierarchy associated with depths within the scene for each image, wherein the depth hierarchy defines depths larger than a specified focal distance as background depths and depths smaller than the specified focal distance as foreground depths; and
densifying the foreground depths in each depth hierarchy.

5. The method of claim 1, further comprising:
separating image data of at least some of the images into foreground image data and background image data; and
performing object reconstruction for each of the at least some of the images, the object reconstruction comprising reconstructing an object associated with the foreground image data in the region of the scene on which the user is focused;
wherein rendering the final views of the scene comprises rendering at least some of the final views of the scene using the reconstructed object.

6. The method of claim 5, wherein:
reconstructing the object comprises:
saving a reconstructed object associated with one of the images; and
for each of one or more subsequent images, transforming the saved reconstructed object based on a predicted head pose of the user to generate a transformed reconstructed object; and
rendering the final views of the scene comprises rendering at least one of the final views of the scene using the transformed reconstructed object.

7. The method of claim 6, further comprising:
generating the predicted head pose of the user for each of the one or more subsequent images, the predicted head pose of the user based on a latency of a pipeline between capture of the images and presentation of the final views of the scene based on the images.

8. A video see-through (VST) extended reality (XR) device comprising:
at least one display;
one or more imaging sensors; and
at least one processing device configured to:
obtain images of a scene captured using the one or more imaging sensors;
identify a region of the scene on which a user of the VST XR device is focused;
generate a mask for each image based on the region of the scene on which the user is focused, wherein different ones of the masks are associated with at least one of (i) different resolutions or (ii) different shapes;
map at least some image data of each image onto a mesh based on the mask associated with that image; and
render final views of the scene using the mapped image data of the images for presentation on the at least one display.

9. The VST XR device of claim 8, wherein:
the mask associated with each image identifies the region of the scene on which the user is focused; and
a portion of the mask associated with the region of the scene on which the user is focused has a higher resolution than one or more other portions of the mask.

10. The VST XR device of claim 8, wherein, to generate the mask for each image, the at least one processing device configured to generate, for each image, a mask defining a region with a first shape or a second shape depending on whether the user is focusing on a closer or farther object in the scene.

11. The VST XR device of claim 8, wherein the at least one processing device is further configured to:
generate a depth hierarchy associated with depths within the scene for each image, wherein the depth hierarchy defines depths larger than a specified focal distance as background depths and depths smaller than the specified focal distance as foreground depths; and
densify the foreground depths in each depth hierarchy.

12. The VST XR device of claim 8, wherein the at least one processing device is further configured to:
separate image data of at least some of the images into foreground image data and background image data; and
perform object reconstruction for each of the at least some of the images, the object reconstruction comprising reconstructing an object associated with the foreground image data in the region of the scene on which the user is focused; and
wherein, to render the final views of the scene, the at least one processing device is configured to render at least some of the final views of the scene using the reconstructed object.

13. The VST XR device of claim 12, wherein:
to reconstruct the object, the at least one processing device is configured to:
save a reconstructed object associated with one of the images; and
for each of one or more subsequent images, transform the saved reconstructed object based on a predicted head pose of the user to generate a transformed reconstructed object; and
to render the final views of the scene, the at least one processing device is configured to render at least one of the final views of the scene using the transformed reconstructed object.

14. The VST XR device of claim 13, wherein the at least one processing device is further configured to generate the predicted head pose of the user for each of the one or more subsequent images, the predicted head pose of the user based on a latency of a pipeline between capture of the images and presentation of the final views of the scene based on the images.

15. A non-transitory machine readable medium containing instructions that when executed cause at least one processor of a video see-through (VST) extended reality (XR) device to:
obtain images of a scene captured using one or more imaging sensors of the VST XR device;
identify a region of the scene on which a user of the VST XR device is focused;
generate a mask for each image based on the region of the scene on which the user is focused, wherein different ones of the masks are associated with at least one of (i) different resolutions or (ii) different shapes;
map at least some image data of each image onto a mesh based on the mask associated with that image; and
render final views of the scene using the mapped image data of the images for presentation on at least one display of the VST XR device.

16. The non-transitory machine readable medium of claim 15, wherein:
the mask associated with each image identifies the region of the scene on which the user is focused; and
a portion of the mask associated with the region of the scene on which the user is focused has a higher resolution than one or more other portions of the mask.

17. The non-transitory machine readable medium of claim 15, wherein the instructions that when executed cause the at least one processor to generate the mask for each image comprise:
instructions that when executed cause the at least one processor to generate, for each image, a mask defining a region with a first shape or a second shape depending on whether the user is focusing on a closer or farther object in the scene.

18. The non-transitory machine readable medium of claim 15, further containing instructions that when executed cause the at least one processor to:
generate a depth hierarchy associated with depths within the scene for each image, wherein the depth hierarchy defines depths larger than a specified focal distance as background depths and depths smaller than the specified focal distance as foreground depths; and
densify the foreground depths in each depth hierarchy.

19. The non-transitory machine readable medium of claim 15, further containing instructions that when executed cause the at least one processor to:
separate image data of at least some of the images into foreground image data and background image data; and
perform object reconstruction for each of the at least some of the images, the object reconstruction comprising reconstructing an object associated with the foreground image data in the region of the scene on which the user is focused;
wherein the instructions that when executed cause the at least one processor to render the final views of the scene comprise instructions that when executed cause the at least one processor to render at least some of the final views of the scene using the reconstructed object.

20. The non-transitory machine readable medium of claim 19, wherein:
the instructions that when executed cause the at least one processor to reconstruct the object comprise instructions that when executed cause the at least one processor to:
save a reconstructed object associated with one of the images; and
for each of one or more subsequent images, transform the saved reconstructed object based on a predicted head pose of the user to generate a transformed reconstructed object; and
the instructions that when executed cause the at least one processor to render the final views of the scene comprise instructions that when executed cause the at least one processor to render at least one of the final views of the scene using the transformed reconstructed object.
